(19) United States
(12) Patent Application Publication
(10) Pub. No.: US 2025/0075753 A1
(43) Pub. Date: Mar. 6, 2025

(54) FLOATING-TYPE DISC BRAKE DEVICE

(71) Applicant: AKEBONO BRAKE INDUSTRY CO., LTD., Chuo-ku, Tokyo (JP)

(72) Inventor: Tatsuya SUZUKI, Tokyo (JP)

(73) Assignee: AKEBONO BRAKE INDUSTRY CO., LTD., Chuo-ku, Tokyo (JP)

(21) Appl. No.: 18/720,030

(22) PCT Filed: Dec. 16, 2022
(86) PCT No.: PCT/JP2022/046443

§ 371 Date: Nov. 26, 2024

(30) Foreign Application Priority Data
Dec. 17, 2021 (JP) 2021-205029

(51) Int. Cl. F16D 55/227; F16D 55/00; F16D 65/00; F16D 65/095

(52) U.S. Cl. CPC F16D 55/227; F16D 65/0056; F16D 65/0068; F16D 65/095; F16D 2055/0008; F16D 2055/0016

(57) ABSTRACT

This floating-type disc brake device (1) is configured to comprise an inner pad (4), an outer pad (5), a support (2), and a caliper body (3). An overhanging part (32) is provided to substantially the entirety of a portion that is of an outer body part (21) constituting the caliper body (3) and that faces a substrate part (49b) of the outer pad (5) in the axial direction. An axially inner surface of the overhanging part (32) has formed thereon a projecting abutment part (33) where the area of a portion that faces a radially inner half of the substrate part (49b) in the axial direction is greater than the area of a portion that faces a radially outer half of the substrate part (49b) in the axial direction. At the time of braking, only the leading end surface of the projecting abutment part (33) is brought into contact with an axially outer surface of the substrate part (49b).

### TECHNICAL FIELD

The present invention relates to a floating-type disc brake device.

### BACKGROUND ART

Disc brake devices are widely used for braking automobiles and motorcycles. During braking by the disc brake device, a pair of pads disposed on both axial sides of a rotor rotating together with a wheel are pressed against both axial side surfaces of the rotor by a piston. As such a disc brake device, various structures have been known in the related art. For example, a floating-type disc brake device as described in JPH07-38771U (Patent Literature 1) is advantageous in terms of weight reduction and cost reduction, and thus the floating-type disc brake device has been widely used in the related art.

The floating-type disc brake device includes a support fixed to a vehicle body, a caliper body supported to be movable in an axial direction with respect to the support, and an inner pad and an outer pad that are supported to be movable in the axial direction with respect to the support. The axial direction refers to an axial direction of the rotor unless otherwise specified.

The caliper body includes a cylinder, and includes an inner body portion disposed on an axially inner side of the rotor, and an outer body portion that presses the outer pad in the axial direction. A piston that presses the inner pad in the axial direction during braking is fitted into the cylinder provided in the inner body portion.

When braking is performed, pressure oil is fed from a master cylinder to the cylinder, and the inner pad is pressed against an axial side surface of the rotor by the piston. Thus, the caliper body moves to the axially inner side with respect to the support by the reaction of a pressing force. Accordingly, the outer body portion presses the outer pad against the axial side surface of the rotor. As a result, the rotor is strongly clamped by the inner pad and the outer pad from both axial sides to perform braking.

### CITATION LIST

### Patent Literature

Patent Literature 1: JPH07-38771U

### SUMMARY OF INVENTION

### Technical Problem

The disc brake device having a configuration in which the outer body portion constituting the caliper body directly presses the outer pad during braking has the following problem to be improved.

That is, the outer body portion has a cantilever structure in which the outer body portion is connected to the inner body portion only at a radially outer side portion. Therefore, as shown in FIG. 25 in an exaggerated manner, a pad pressing portion 100a of an outer body portion 100 that presses an outer pad 101 produces elastic deformation to rise to a radially outer side and an axially outer side during braking. Therefore, an amount of elastic deformation of the pad pressing portion 100a is larger in a radially inner side portion than in the radially outer side portion. Accordingly, when a structure is adopted in which the pad pressing portion of the outer body portion is brought into contact with an entire surface of the outer pad, there is a possibility that a surface pressure of a contact portion between the outer body portion and the outer pad becomes locally high at a radially outer side portion (an outer peripheral edge portion) of the outer pad. As a result, uneven wear may occur in the outer pad, or noise may occur during braking.

The present invention has been made to solve the above problem, and an object of the present invention is to provide a floating-type disc brake device capable of suppressing a surface pressure of a contact portion between an outer body portion of a caliper body and an outer pad from locally increasing in a radially outer side portion of the outer pad.

### Solution to Problem

A floating-type disc brake device according to one aspect of the present invention includes an inner pad, an outer pad, a support, and a caliper body.

The inner pad is configured to be disposed on an axially inner side of a rotor.

The outer pad is configured to be disposed on an axially outer side of the rotor.

The support is configured to be fixed to a vehicle body and is configured to support the inner pad and the outer pad such that the inner pad and the outer pad are movable in an axial direction.

The caliper body is supported to be movable in the axial direction with respect to the support.

The outer pad includes a protruding portion configured to protrude the axially inner side over substantially an entire portion facing the base plate portion in the axial direction.

The protruding portion includes, on an axially inner side surface (a distal end surface) thereof, a contact convex portion configured to rise in the axial direction and in which an area of a portion facing a radially inner side half portion of the base plate portion in the axial direction is larger than an area of a portion facing a radially outer side half portion of the base plate portion in the axial direction.

In the outer body portion, only a distal end surface of the contact convex portion is configured to be brought into contact with an axially outer side surface (a back surface) of the base plate portion during braking.

In the floating-type disc brake device according to one aspect of the present invention, the outer body portion may include a pair of relief recessed portions recessed to the axially outer side on both circumferentially outer side portions of the protruding portion, the pair of relief recessed portions may allow an axially outer side portion of the support to be inserted when wear of the inner pad and the outer pad progresses.

In the floating-type disc brake device according to one aspect of the present invention, an axial height of the contact convex portion may be constant.

In the floating-type disc brake device according to one aspect of the present invention, the contact convex portion may include a strip-shaped radial convex portion that extends in a radial direction.

In this case, the radial convex portion may be disposed on a central axis of the cylinder or in a vicinity of the central axis.

In the floating-type disc brake device according to one aspect of the present invention, a plurality of radial convex portions may be provided to be separated from each other in a circumferential direction, and the plurality of radial convex portions may be disposed in parallel to each other.

In the floating-type disc brake device according to one aspect of the present invention, the protruding portion may include a reinforcing rib on an outer circumferential edge portion of the axially inner side surface of the protruding portion, the outer peripheral edge portion may be deviated on a radially outer side from a portion facing the base plate portion in the axial direction, and a radially outer side end of each of the radial convex portions may be connected to the reinforcing rib.

In the floating-type disc brake device according to one aspect of the present invention, the contact convex portion may include a strip-shaped circumferential convex portion that extends in a circumferential direction.

In this case, the circumferential convex portion may be disposed to intersect the radial convex portion.

In the floating-type disc brake device according to one aspect of the present invention, a plurality of circumferential convex portions may be provided to be separated from each other in a radial direction.

In the floating-type disc brake device according to one aspect of the present invention, the circumferential convex portion may be disposed at least one of a radial position intersecting a central axis of the cylinder and a position deviated on a radially inner side of a central axis of the cylinder.

In the floating-type disc brake device according to one aspect of the present invention, the circumferential convex portion may be curved to be convex on a radially outer side.

In the floating-type disc brake device according to one aspect of the present invention, the circumferential convex portion may extend linearly in the circumferential direction.

In the floating-type disc brake device according to one aspect of the present invention, the outer body portion may have a circumferential dimension larger than a circumferential dimension of the support.

### Advantageous Effects of Invention

According to the present invention, it is possible to realize a floating-type disc brake device capable of suppressing a surface pressure of a contact portion between an outer body portion of a caliper body and an outer pad from locally increasing in a radially outer side portion of the outer pad.

### BRIEF DESCRIPTION OF DRAWINGS

FIG. 1 is a front view of a disc brake device according to a first embodiment as viewed from an axially outer side.

FIG. 2 is a rear view of the disc brake device according to the first embodiment as viewed from the axially inner side.

FIG. 3 is a plan view of the disc brake device according to the first embodiment as viewed from a radially outer side.

FIG. 4 is a bottom view of the disc brake device according to the first embodiment as viewed from the radially inner side.

FIG. 5 is a side view of the disc brake device according to the first embodiment as viewed from a right side of FIG. 1.

FIG. 6 is a perspective view of the disc brake device according to the first embodiment as viewed from the axially outer side and the radially outer side.

FIG. 7 is a perspective view of the disc brake device according to the first embodiment as viewed from the axially inner side and the radially outer side.

FIG. 8 is a perspective view of the disc brake device according to the first embodiment as viewed from the axially outer side and the radially inner side.

FIG. 9 is a perspective view of the disc brake device according to the first embodiment as viewed from the axially inner side and the radially inner side.

FIG. 10 is a perspective view as viewed from the axially outer side and the radially outer side with a caliper body removed from the disc brake device according to the first embodiment.

FIG. 11 is a perspective view as viewed from the axially inner side and the radially outer side with the caliper body removed from the disc brake device according to the first embodiment.

FIG. 12 is a perspective view as viewed from the axially outer side and the radially inner side with the caliper body removed from the disc brake device according to the first embodiment.

FIG. 13 is a perspective view as viewed from the axially inner side and the radially inner side with the caliper body removed from the disc brake device according to the first embodiment.

FIG. 14 is a view as viewed from the axially outer side with an outer body portion of the caliper body removed from the disc brake device according to the first embodiment.

FIG. 15 is a view as viewed from the axially inner side with the outer body portion of the caliper body removed from the disc brake device according to the first embodiment.

FIG. 16 is a view as viewed from the axially inner side with the outer body portion and an outer pad of the caliper body removed from the disc brake device according to the first embodiment.

FIG. 17 is a partial transparent view as viewed from the axially inner side with the outer body portion and an outer pad of the caliper body removed from the disc brake device according to the first embodiment.

FIG. 18 is a view as viewed from the axially outer side with a support and a pad clip removed from the disc brake device according to the first embodiment.

FIG. 19 is a right side view of FIG. 18.

FIG. 20 is a perspective view as viewed from the axially outer side and the radially outer side with the support and the pad clip removed from the disc brake device according to the first embodiment.

FIG. 21 is a partial perspective view of an assembled state of the inner pad and the outer pad to the support as viewed from the axially inner side and the radially outer side, regarding the first embodiment.

FIG. 22 is a view as viewed from the axially outer side with the outer pad removed from the disc brake device according to the first embodiment.

FIG. 23 is a view corresponding to FIG. 15, showing a second embodiment.

FIG. 24 is a view corresponding to FIG. 15, showing a third embodiment.

FIG. 25 is a schematic view of the caliper body as viewed from a circumferentially outer side, which is shown to explain a problem of a structure of a related art.

### DESCRIPTION OF EMBODIMENTS

### First Embodiment

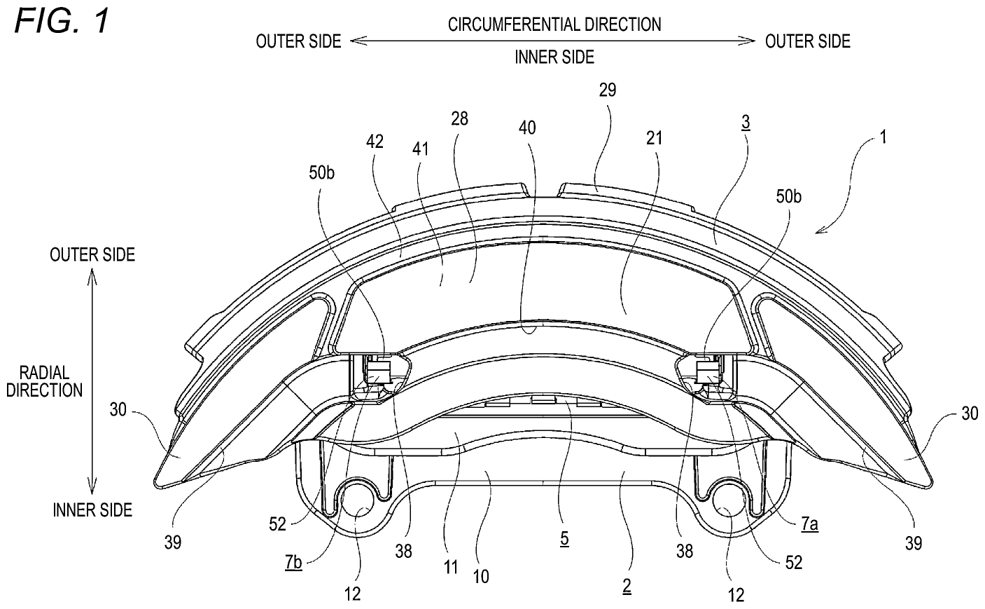

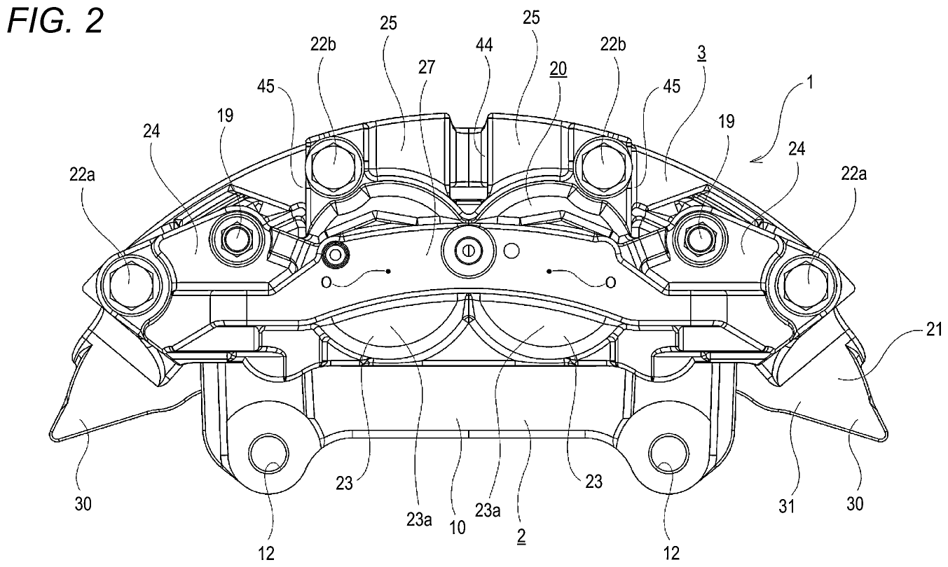

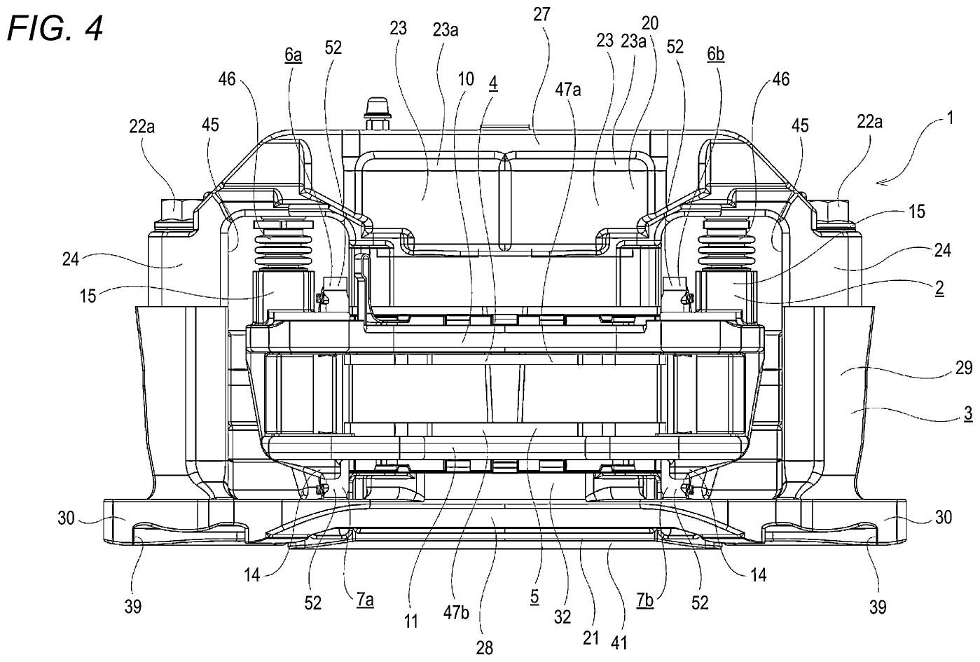

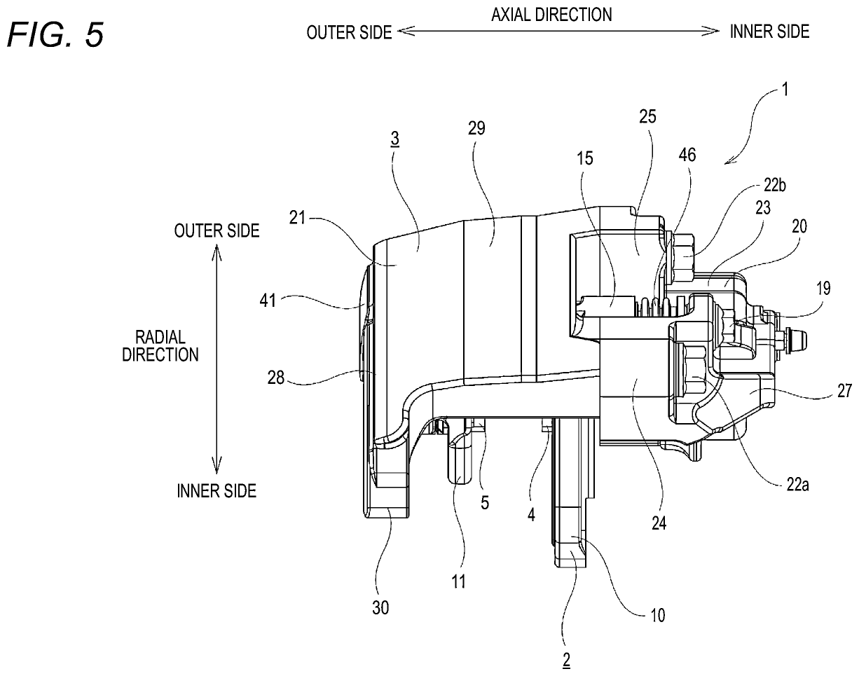

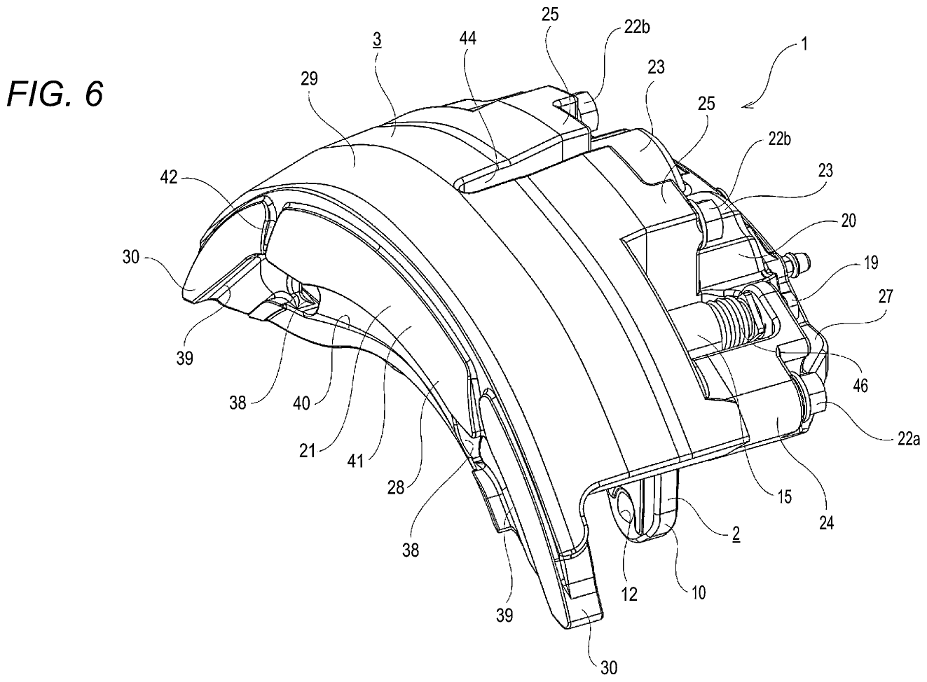

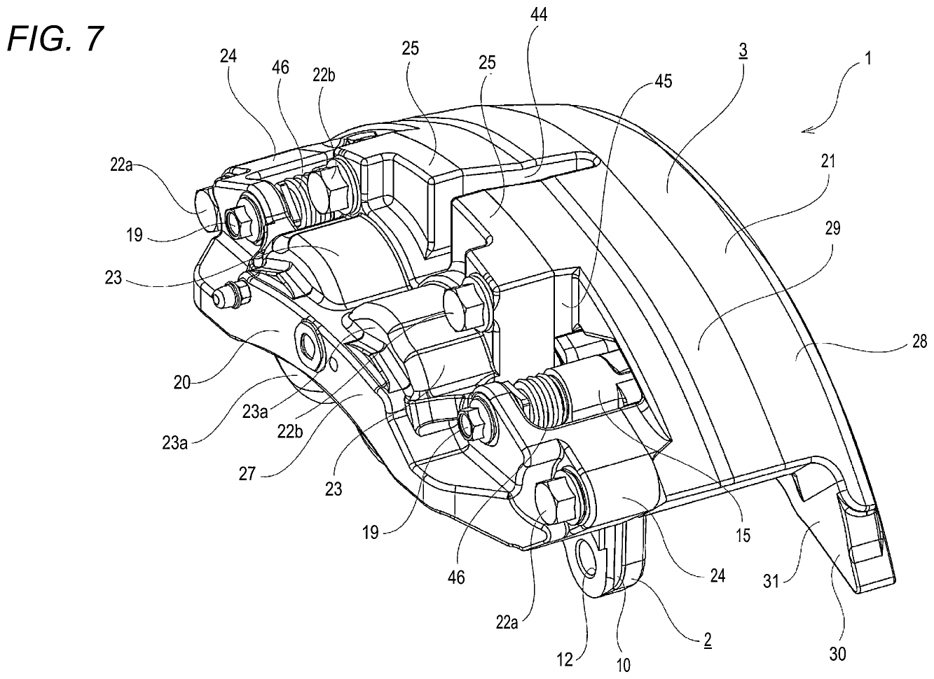

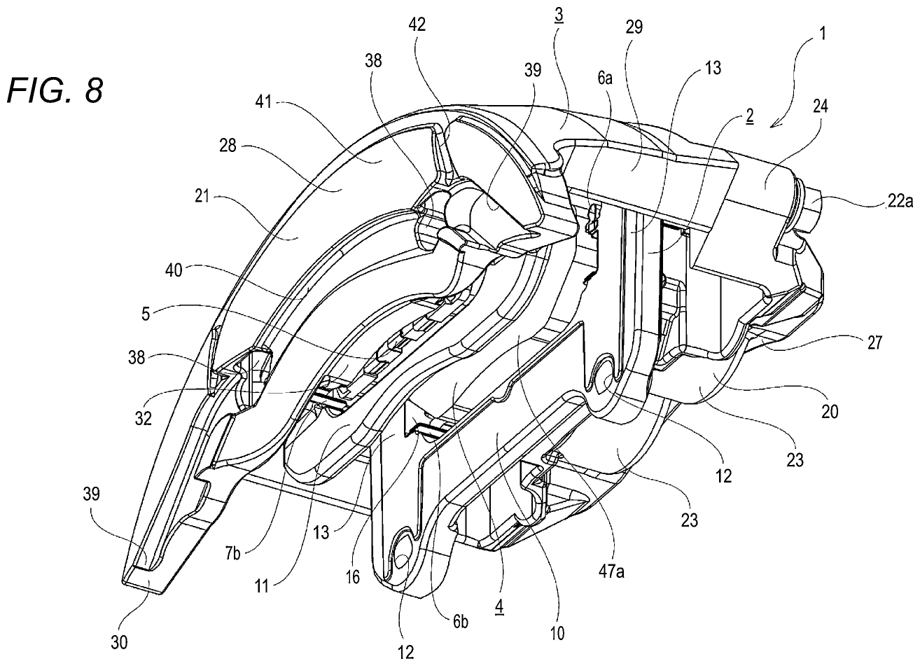

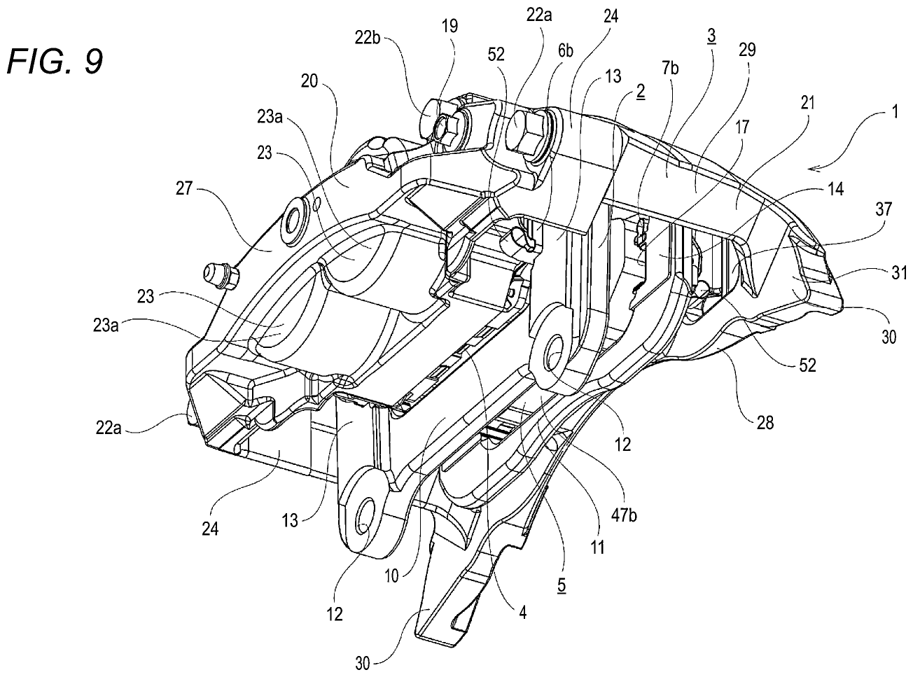

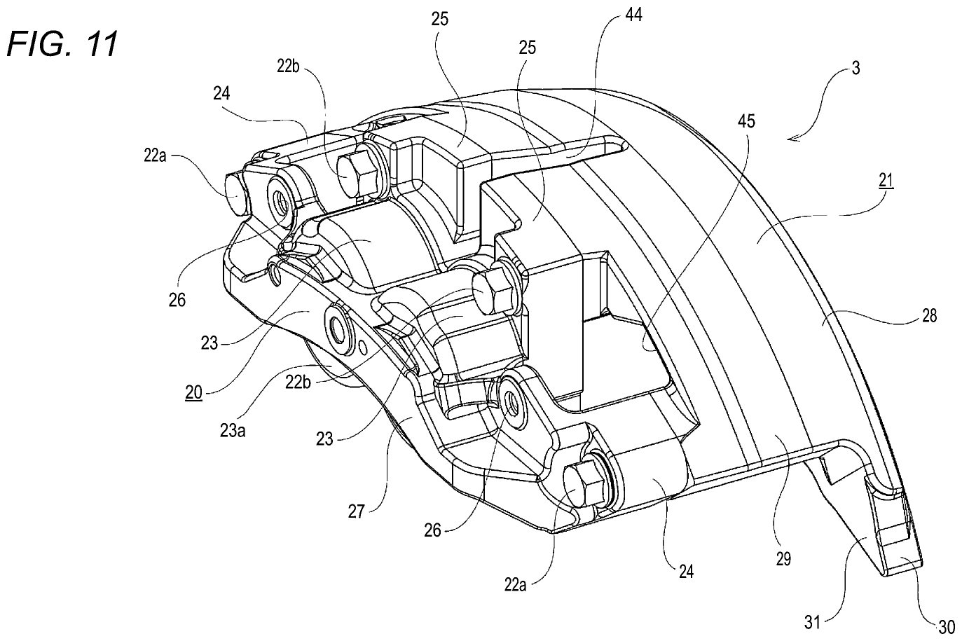

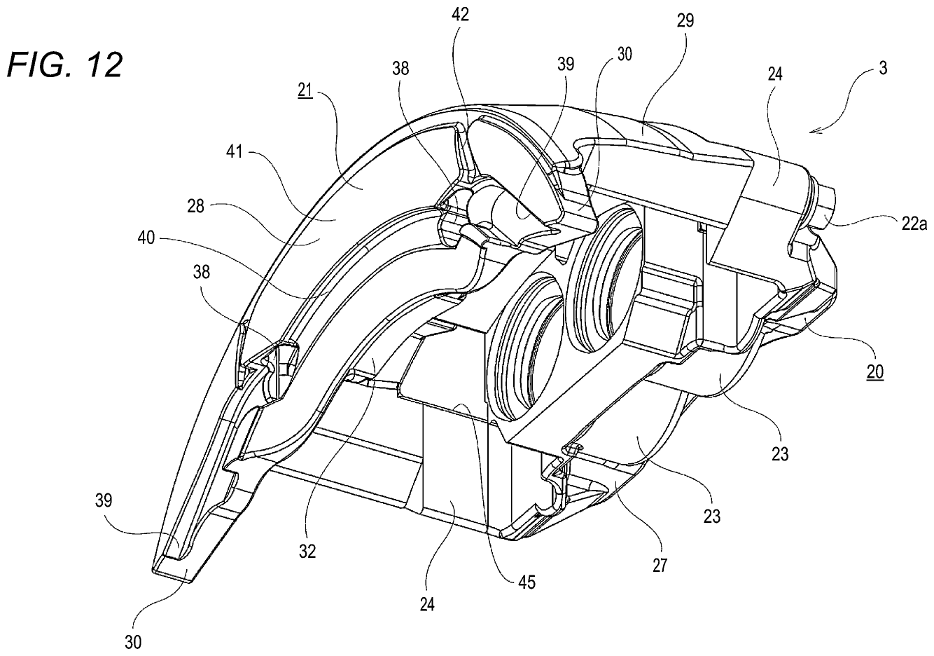

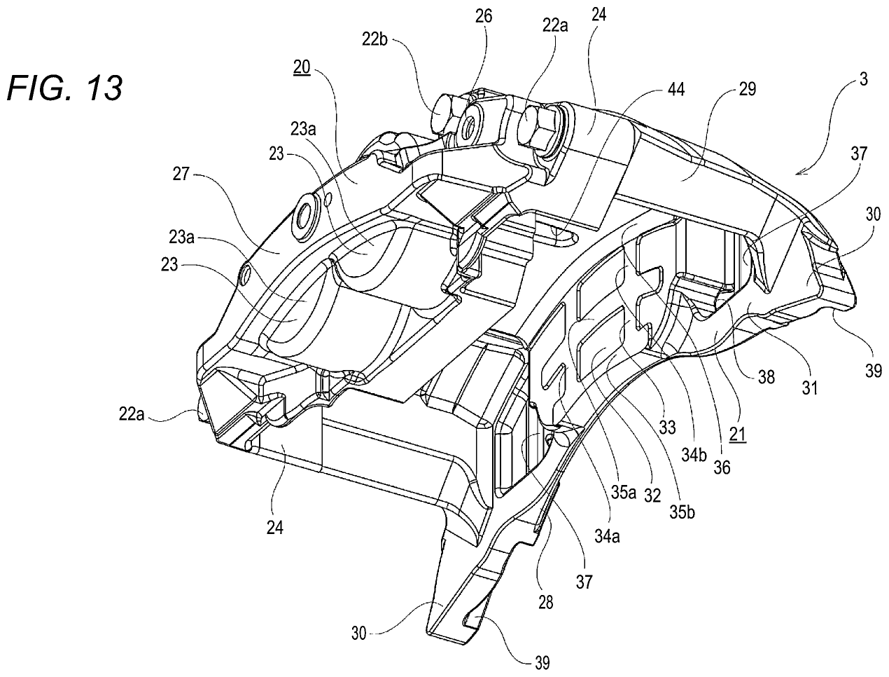

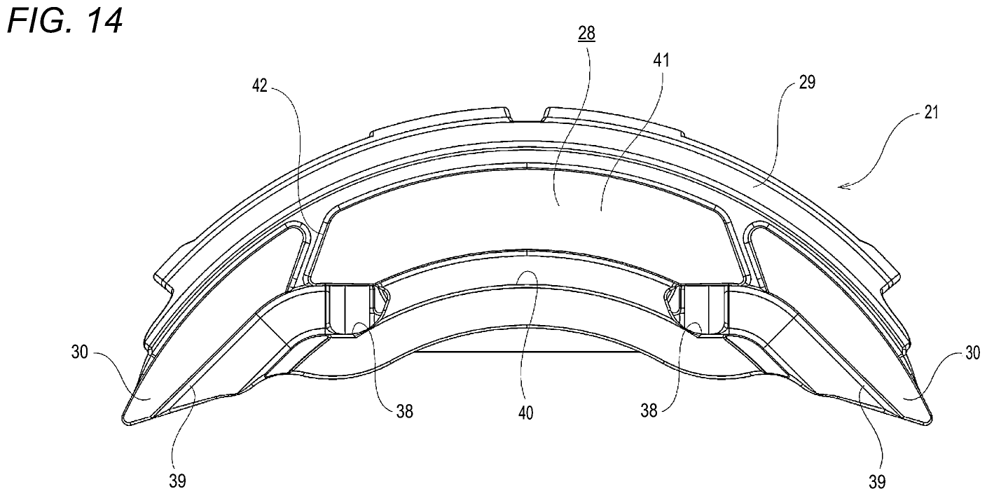

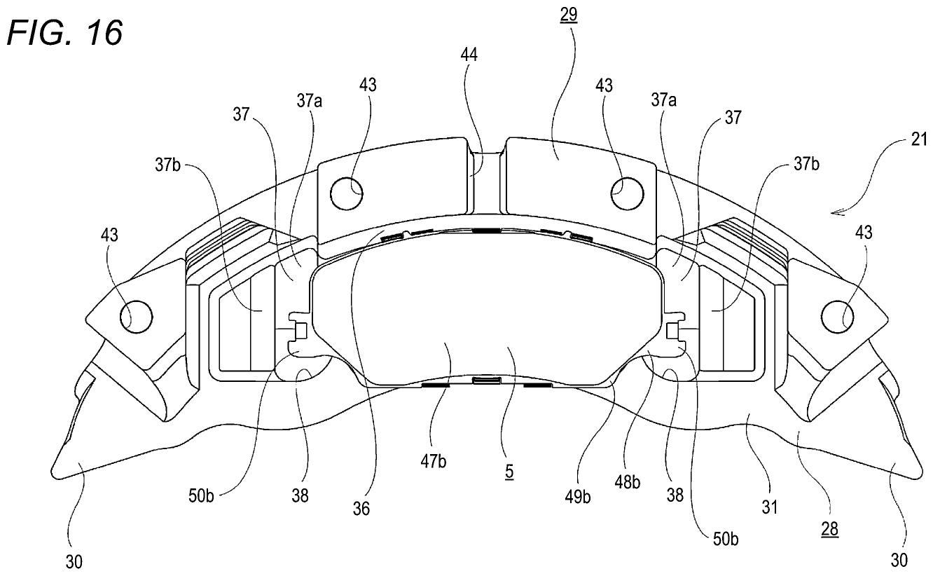

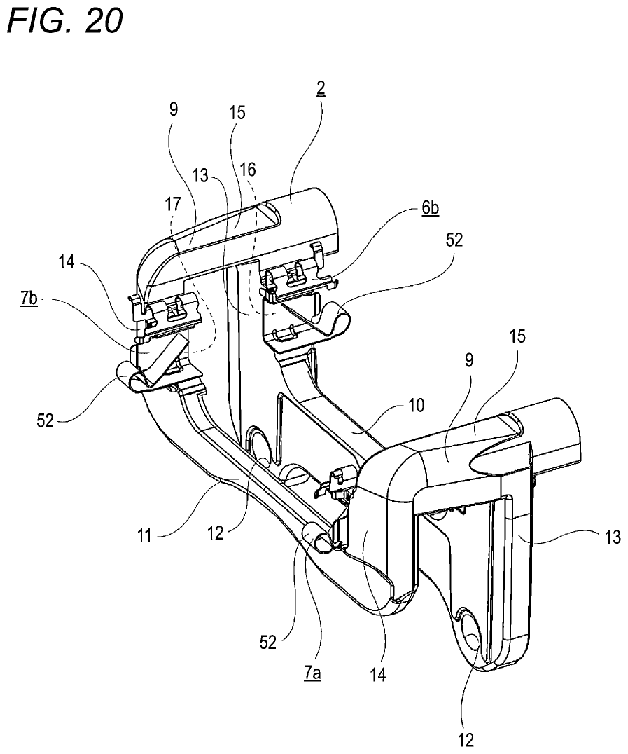

A first embodiment will be described with reference to FIGS. 1 to 22.

In the present specification and claims, an “axial direction”, a “radial direction”, and a “circumferential direction” refer to an axial direction, a radial direction, and a circumferential direction of a disc-shaped rotor that rotates together with a wheel, unless otherwise specified. In addition, in a state where a disc brake device is attached to a vehicle body, an outer side in a width direction of the vehicle body is referred to as an axially outer side, and a central side in the width direction of the vehicle body is referred to as an axially inner side. In addition, a circumferentially central side of the disc brake device is referred to as a circumferentially inner side, and both circumferential sides of the disc brake device are referred to as circumferentially outer sides. Further, a rotation-in side refers to a side where the rotor enters a caliper body, and a rotation-out side refers to a side to which the rotor exits from the caliper body.

### Description of Structure of Disc Brake Device

A disc brake device 1 according to the present embodiment is a floating-type disc brake device, and includes a support 2, a caliper body 3, an inner pad 4, and an outer pad 5.

### Support

The support 2 is a cast product made of an iron alloy such as cast iron, and is fixed to a vehicle body. The support 2 supports the caliper body 3 such that the caliper body 3 is movable in an axial direction, and supports each of the inner pad 4 and the outer pad 5 such that the inner pad 4 and the outer pad 5 are movable in the axial direction.

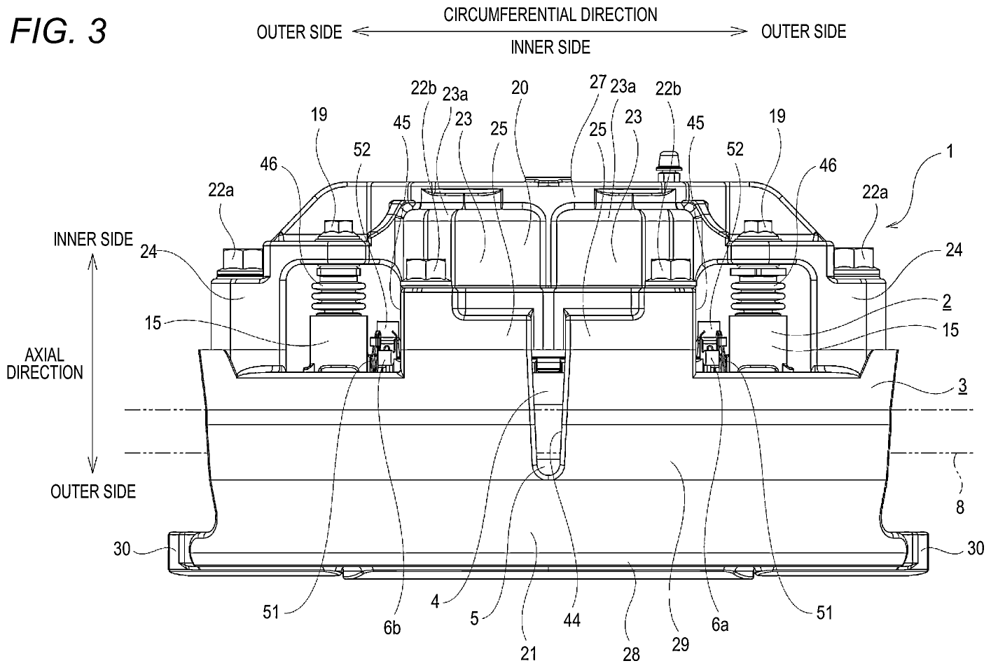

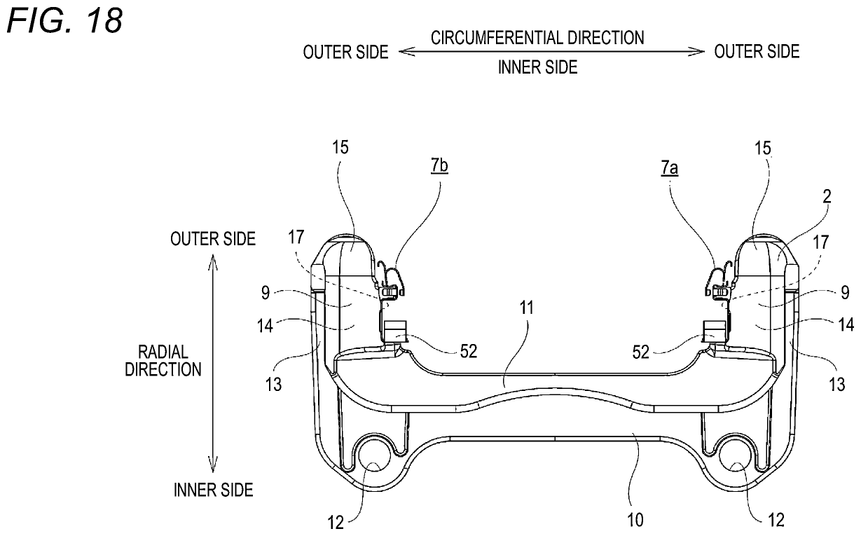

As shown in FIGS. 18 to 20, the support 2 includes a pair of guide portions 9 disposed on both circumferentially outer side ends, an inner side circumferential connection portion 10 disposed on an axially inner side of a rotor 8 (not shown in FIGS. 18 to 20, see FIG. 3) and extending in a circumferential direction, and an outer side circumferential connection portion 11 disposed on an axially outer side of the rotor 8 and extending in the circumferential direction. The support 2 is fixed to a suspension device constituting a vehicle body by using a pair of attachment holes 12 provided on both circumferentially outer side ends of the inner side circumferential connection portion 10. In the case of implementing the present invention, the outer side circumferential connection portion 11 may be omitted from the support 2.

Each of the pair of guide portions 9 has an inverted U-shape as viewed in the circumferential direction, and is disposed to straddle the rotor 8 from the radially outer side. Each of the pair of guide portions 9 includes an inner guide portion 13 that supports the inner pad 4 such that the inner pad 4 is movable in the axial direction, an outer guide portion 14 that supports the outer pad 5 such that the outer pad 5 is movable in the axial direction, and a caliper guide portion 15 that connects a radially outer side ends of each of the inner guide portion 13 and the outer guide portion 14 in the axial direction.

The inner guide portion 13 is disposed on the axially inner side of the rotor 8 and extends in the radial direction. A radially inner side end of the inner guide portion 13 is connected to a circumferentially outer side end of the inner side circumferential connection portion 10. The inner guide portion 13 includes an inner side guide recessed groove 16 recessed toward the circumferentially outer side on a radially inner side portion of a circumferentially inner side surface. The inner side guide recessed groove 16 is engageable with an ear portion 50a (to be described later) provided in the inner pad 4.

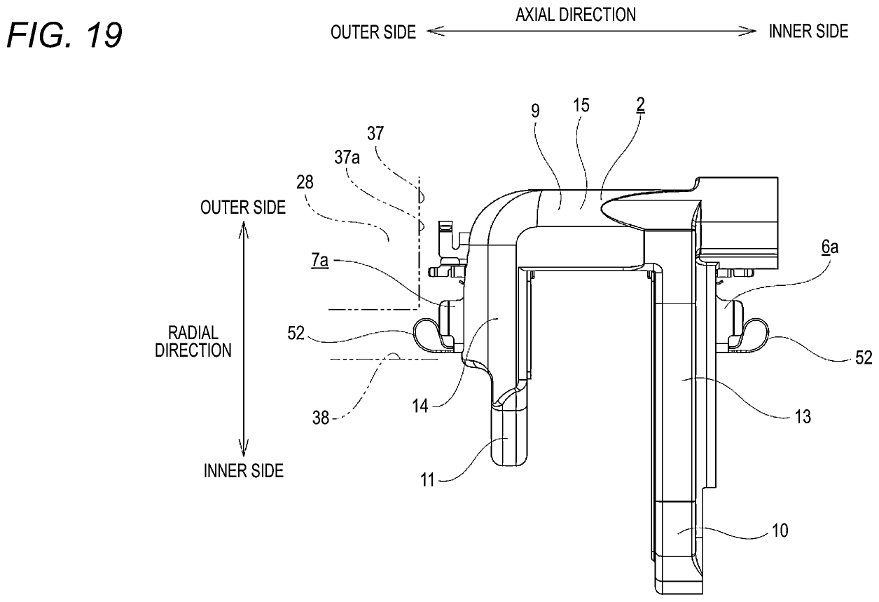

The outer guide portion 14 is disposed on the axially outer side of the rotor 8 and extends in the radial direction. The radially inner side end of the outer guide portion 14 is connected to the circumferentially outer side end of the outer side circumferential connection portion 11. The outer guide portion 14 includes an outer side guide recessed groove 17 recessed toward the circumferentially outer side on the radially inner side portion of the circumferentially inner side surface. The outer side guide recessed groove 17 is engageable with an ear portion 50b (to be described later) provided in the outer pad 5. As shown in FIG. 19, an axially outer side surface of the outer guide portion 14 protrudes to the axially outer side with respect to an axially outer side surface of the outer side circumferential connection portion 11.

The caliper guide portion 15 is disposed on a radially outer side of the rotor 8 and extends in the axial direction. A support hole 18 that extends in the axial direction is formed inside the caliper guide portion 15. The support hole 18 opens in an axially inner side surface of the caliper guide portion 15. A front half portion of a slide pin 19 (to be described later) is slidably inserted into the support hole 18. An axially inner side end of the caliper guide portion 15 is disposed to protrude to the axially inner side with respect to the inner guide portion 13.

### Caliper Body

The caliper body 3 is supported to be movable in the axial direction with respect to the support 2 using the pair of slide pins 19.

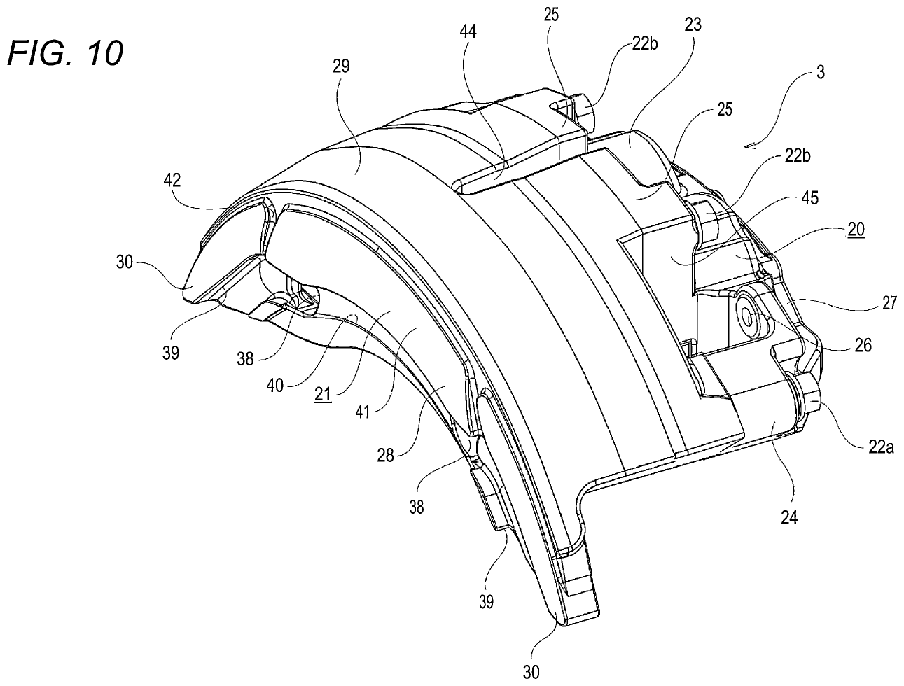

The caliper body 3 according to the present embodiment has a divided structure rather than an integral structure. That is, as shown in FIGS. 10 to 13, the caliper body 3 is configured by connecting an inner body portion 20 and an outer body portion 21 which are configured separately from each other in the axial direction by a plurality of (in the shown example, four in total) connection members 22a and 22b. The plurality of connection members 22a and 22b are disposed to be separated from each other in the circumferential direction. Of the plurality of connection members 22a and 22b, a pair of connection members 22a disposed on both circumferentially outer sides connects the inner body portion 20 and the outer body portion 21 on both circumferentially outer side ends in the axial direction, and the remaining connection members 22b connect the inner body portion 20 and the outer body portion 21 on circumferentially inner side portions (near the center) to each other in the axial direction. When the present invention is implemented, the number of connection members is not particularly limited. In addition, when the present invention is implemented, the caliper body may have an integral structure.

The inner body portion 20 and the outer body portion 21 may be made of different materials or may be made of the same material. In the present embodiment, both the inner body portion 20 and the outer body portion 21 are made of an aluminum alloy, but may be made of an iron alloy or another material. Further, one of the inner body portion 20 and the outer body portion 21 may be made of an aluminum alloy, and the other of the inner body portion 20 and the outer body portion 21 may be made of an iron alloy or another material.

### Inner Body Portion

The inner body portion 20 is disposed on the axially inner side of the rotor 8. The inner body portion 20 includes a pair of cylinders 23, a pair of circumferential arm portions 24, a pair of radially protruding portions 25, and a strip-shaped rib 27. When the present invention is implemented, the number of cylinders provided in the inner body portion is not particularly limited, and only one cylinder or three or more cylinders may be provided.

The pair of cylinders 23 are provided in a circumferentially inner side portion (an intermediate portion) of the inner body portion 20. The pair of cylinders 23 are disposed side by side in the circumferential direction in a state where central axes O of pair of cylinders 23 are parallel to a central axis of the rotor 8. The cylinder 23 has a substantially cylindrical shape and opens only to the axially outer side. A piston (not shown) is fitted into the cylinder 23 to be movable in the axial direction.

The pair of circumferential arm portions 24 are provided on both circumferentially outer side portions of the inner body portion 20. The pair of circumferential arm portions 24 are disposed on both circumferential outer sides of the pair of cylinders 23. Each circumferential arm portion 24 extends to the circumferentially outer side from an outer circumferential surface of the cylinder 23.

The circumferential arm portion 24 includes an insertion hole through which the connection member 22a is inserted in the axial direction on a circumferentially outer side end (a distal end portion), and includes a fixing hole 26 for fixing a base end portion of the slide pin 19 in a circumferentially intermediate portion. The circumferentially outer side end of the circumferential arm portion 24 is offset to the axially outer side compared to a circumferentially inner side end and an intermediate portion of the circumferential arm portion 24. Therefore, the circumferential arm portion 24 has a substantially L shape as viewed in the radial direction. An axially outer side surface on the circumferentially outer side end of the circumferential arm portion 24 is a flat surface.

The pair of radially protruding portions 25 are disposed in the circumferentially inner side portion (the intermediate portion) of the inner body portion 20 in a state of being separated from each other in the circumferential direction. The pair of radially protruding portions 25 are disposed on the radially outer sides of the axially outer side portions of the pair of cylinders 23. Each of the radially protruding portions 25 is formed in a flat plate shape and extends to the radially outer side from the outer circumferential surface of the cylinder 23. The radially protruding portion 25 includes an insertion hole through which the connection member 22b is inserted in the axial direction. An axially outer side surface of the radially protruding portion 25 is a flat surface, and is located on the same virtual plane as the axially outer side surface on the circumferentially outer side end of the circumferential arm portion 24.

The strip-shaped rib 27 is a thick portion having a larger wall thickness (rise to the axially inner side) than other portions, and is provided on an axially inner side surface of the inner body portion 20. Therefore, the inner body portion 20 has an increased wall thickness and an improved rigidity at a portion where the strip-shaped rib 27 is provided.

The strip-shaped rib 27 extends in the circumferential direction and covers the bottom portions 23a of the pair of cylinders 23 from the axially inner side so as to cross the bottom portions 23a in the circumferential direction. The both circumferentially outer side ends of the strip-shaped rib 27 extend to the circumferentially outer side with respect to the bottom portions 23a of the cylinders 23 and are positioned on the circumferentially outer side ends of the axially inner side surface of the inner body portion 20. Therefore, the strip-shaped rib 27 is provided over substantially an entire length in the circumferential direction of the axially inner side surface of the inner body portion 20.

### Outer Body Portion

The outer body portion 21 includes a substantially arcuate axial cover portion 28 disposed on an axially outer side of the outer pad 5, and a partially cylindrical radial cover portion 29 disposed on the radially outer side of the rotor 8. The outer body portion 21 has a substantially L-shaped cross-sectional shape in relation to a virtual plane including the central axis of the rotor 8. The axial cover portion 28 and the radial cover portion 29 are integrally formed.

The axial cover portion 28 is formed in a substantially arcuate flat plate shape, and directly presses the outer pad 5 in the axial direction during braking. The axial cover portion 28 is a portion that is visible from the outside in a state where the disc brake device 1 is attached to the vehicle body, and a design surface is formed by an axially outer side surface.

In the present embodiment, the circumferential dimension of the axial cover portion 28 is made larger than a circumferential dimension of the support 2, and both circumferentially outer side portions of the axial cover portion 28 protrude to a circumferentially outer side with respect to the pair of guide portions 9. The axial cover portion 28 covers the pair of guide portions 9 from the axially outer side. In other words, the pair of guide portions 9 is not visible from the outside. In the case of the present embodiment, by setting the circumferential dimension of the axial cover portion 28 to be larger than the circumferential dimension of the support 2 as described above, a large design surface constituted by the axially outer side surface of the axial cover portion 28 is secured.

In the present embodiment, the circumferential dimension of the axial cover portion 28 is larger than a circumferential dimension of each of the radial cover portion 29 and the inner body portion 20. For this purpose, a substantially triangular plate-shaped blade portion 30 that protrudes to the circumferentially outer side with respect to the radial cover portion 29 and the inner body portion 20 is provided at both circumferentially outer side ends of the axial cover portion 28.

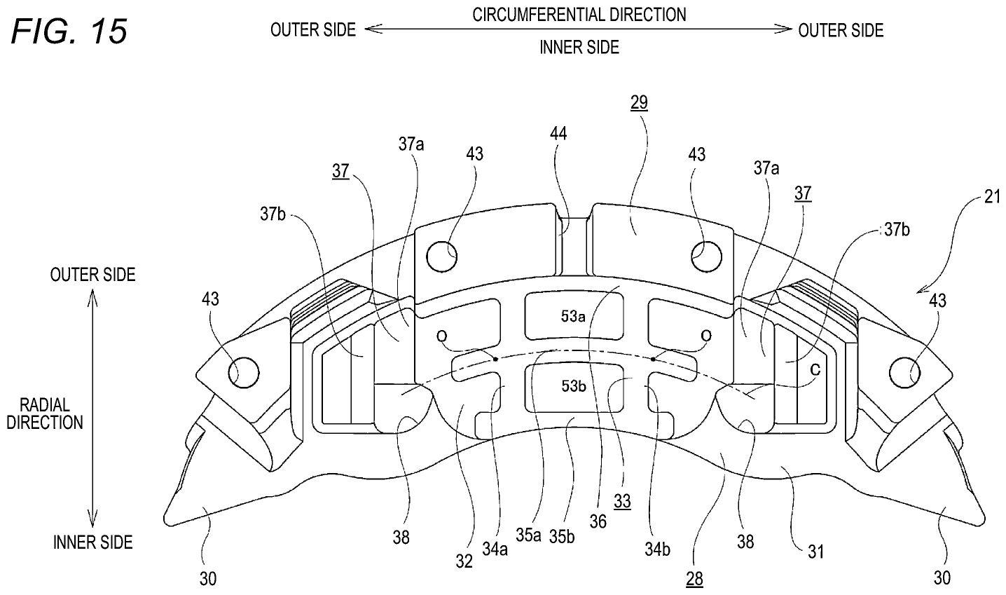

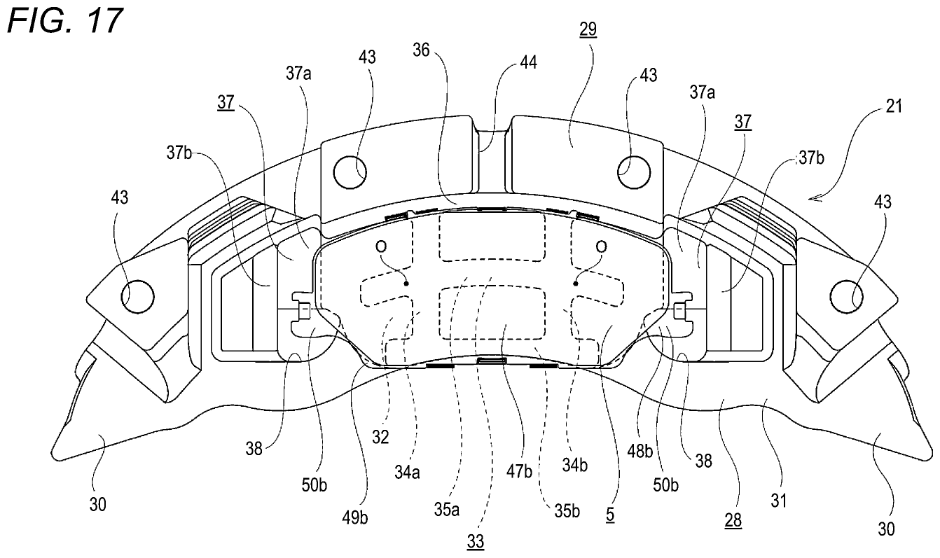

As shown in FIG. 15, the axial cover portion 28 includes a reference surface 31 having a flat surface shape on an axially inner side surface of the axial cover portion 28. The axial cover portion 28 includes a protruding portion 32 that protrudes to the axially inner side with respect to the reference surface 31 in a circumferentially inner side portion of the axially inner side surface of the axial cover portion 28. As shown in FIG. 17, the protruding portion 32 is provided on substantially the entire portion of the axially inner side surface of the axial cover portion 28 that faces a base plate portion 49b (to be described later) constituting the outer pad 5 in the axial direction. Therefore, the protruding portion 32 has a shape that substantially matches the base plate portion 49b of the outer pad 5.

An axially inner side surface (a distal end surface) of the protruding portion 32 is provided with a contact convex portion (rib) 33 that rises to the axially inner side. In the present embodiment, only the contact convex portion 33 of the outer body portion 21 comes into contact with an axially outer side surface (a back surface) of the base plate portion 49b of the outer pad 5 during braking.

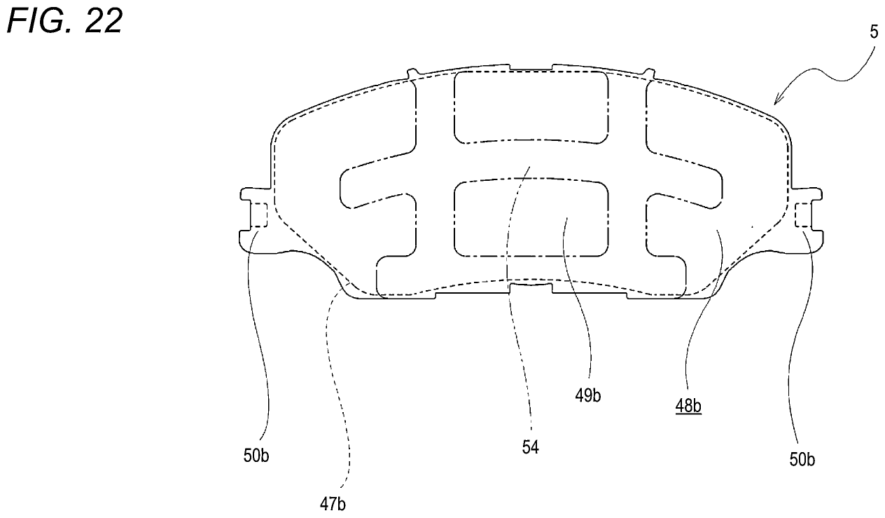

In the present embodiment, an axial height (an amount of protrusion from the reference surface 31) of the contact convex portion 33 from the reference surface 31 is constant, and is, for example, about several millimeters. When the present invention is implemented, the axial height of the contact convex portion may be changed according to at least one of a radial position and a circumferential position of the contact convex portion. In addition, a distal end surface of the contact convex portion 33 is a flat surface formed by machine processing (a machined surface). The reason for this is to enable the distal end surface of the contact convex portion 33 to uniformly come into contact with a contact surface 54 (see FIG. 22) of the base plate portion 49b of the outer pad 5, and to suppress braking noise from occurring due to unstable pressing force on the outer pad 5 due to uneven contact. In addition, the processing time can be shortened as compared with a case where the axially inner side surface of the protruding portion 32 is brought into contact with the entire surface of the base plate portion 49b of the outer pad 5 without providing the contact convex portion 33.

The contact convex portion 33 has a shape in which an area of a portion facing a radially inner side half portion of the base plate portion 49b in the axial direction is larger than an area of a portion facing a radially outer side half portion of the base plate portion 49b in the axial direction. For this reason, in the present embodiment, the contact convex portion 33 has a substantially lattice shape by combining a plurality of radial convex portions 34a and 34b and a plurality of circumferential convex portions 35a and 35b. Accordingly, an area of the distal end surface of the contact convex portion 33 is larger in a portion existing on the radially inner side than in a portion existing on the radially outer side with a virtual circle C, which passes through a central axis O of each of the two cylinders 23 and is centered on the central axis of the rotor 8, sandwiched therebetween.

The contact convex portion 33 includes two radial convex portions 34a and 34b. Each of the radial convex portions 34a and 34b extends linearly in the radial direction and is formed in a strip shape. Width dimensions of the radial convex portions 34a and 34b are constant over the entire length of the radial convex portions 34a and 34b. The two radial convex portions 34a and 34b are disposed in parallel to each other to be separated in the circumferential direction, and are disposed in the vicinity of the circumferentially inner side of the central axis O of each of the cylinders 23. When the present invention is implemented, one or three or more radial convex portions may be provided, and a width dimension of the radial convex portion may be varied according to a radial position.

The contact convex portion 33 includes two circumferential convex portions 35a and 35b. Each of the circumferential convex portions 35a and 35b extends in the circumferential direction and is formed in a strip shape. When the present invention is implemented, one or three or more circumferential convex portions may be provided.

Of the two circumferential convex portions 35a and 35b, the circumferential convex portion 35a disposed on the radially outer side has an arc shape curved such that the radially outer side is convex, and a width dimension of the circumferential convex portion 35a is constant over the entire length. The circumferential convex portion 35a is disposed at a radially intermediate portion of the axially inner side surface of the protruding portion 32, and intersects radially intermediate portions of the two radial convex portions 34a and 34b. In other words, the circumferential convex portion 35a crosses the radially intermediate portions of the two radial convex portions 34a and 34b in the circumferential direction. In addition, the circumferential convex portions 35a is disposed at a radial position intersecting the central axis O of each of the cylinders 23. Therefore, the circumferential convex portion 35a is disposed on the virtual circle C. Both circumferential outer side ends of the circumferential convex portion 35a do not reach a circumferentially outer side end of the axially inner side surface of the protruding portion 32.

Of the two circumferential convex portions 35a and 35b, the circumferential convex portion 35b disposed on the radially inner side has a linear shape, and a width dimension of the circumferential convex portion 35b varies depending on a circumferential position. The circumferential convex portion 35b is disposed at an inner circumferential edge portion (a radially inner side end) of the axially inner side surface of the protruding portion 32, which is deviated to the radially inner side from the central axis O of each of the cylinders 23. The circumferential convex portion 35b is connected to a radially inner side end of each of the two radial convex portions 34a and 34b. In addition, in the circumferential convex portion 35b, a width dimension of each of both circumferential outer side ends existing on the circumferentially outer side of the radial convex portions 34a and 34b is larger than a width dimension of a circumferentially inner side portion existing on the circumferentially inner side of the radial convex portions 34a and 34b. The both circumferential outer side ends of the circumferential convex portion 35b are located on the circumferentially inner side of the both circumferential outer side ends of the circumferential convex portion 35a, and do not reach the circumferentially outer side end of the axially inner side surface of the protruding portion 32.

In the present embodiment, of the two circumferential convex portions 35a and 35b constituting the contact convex portion 33, the circumferential convex portion 35a on the radially outer side is disposed on the virtual circle C located at the radially intermediate portion of the axially inner side surface of the protruding portion 32, and the circumferential convex portion 35b on the radially inner side is disposed at the inner circumferential edge portion of the axially inner side surface of the protruding portion 32. Accordingly, the area of the distal end surface of the contact convex portion 33 is larger in a portion existing on the radially inner side than in a portion existing on the radially outer side with the virtual circle C sandwiched therebetween, by approximately an area of the distal end surface of the circumferential convex portion 35b on the radially inner side.

The protruding portion 32 includes a reinforcing rib 36 on an outer peripheral edge portion of the axially inner side surface of the axial cover portion 28 that is deviated on the radially outer side from a portion facing the base plate portion 49b of the outer pad 5 in the axial direction. The reinforcing rib 36 reinforces a portion between the outer peripheral edge portion of the axially inner side surface of the axial cover portion 28 and an axially outer side end of the radially inner side surface of the radial cover portion 29.

The reinforcing rib 36 extends in the circumferential direction and is formed in a strip shape. The reinforcing rib 36 has an arc shape that is curved such that a radially outer side of the reinforcing rib 36 is convex, and a width dimension of the reinforcing rib 36 is constant over the entire length. Both circumferential outer side ends of the reinforcing rib 36 reach the circumferentially outer side end of the axially inner side surface of the protruding portion 32. Radially outer side ends of the two radial convex portions 34a and 34b constituting the contact convex portion 33 are connected to a circumferentially intermediate portion of the reinforcing rib 36. Since the reinforcing rib 36 is provided at a position deviated on the radially outer side from a portion facing the base plate portion 49b of the outer pad 5 in the axial direction, the reinforcing rib 36 does not come into contact with the axially outer side surface of the base plate portion 49b during braking.

In the present embodiment, by forming the contact convex portion 33 on the axially inner side surface of the protruding portion 32, a substantially rectangular non-contact portion 53a surrounded on four sides by the reinforcing rib 36, the circumferential convex portion 35a, and the pair of radial convex portions 34a and 34b is formed on the axially inner side surface of the protruding portion 32, and a substantially rectangular non-contact portion 53b surrounded on four sides by the pair of circumferential convex portions 35a and 35b and the pair of radial convex portions 34a and 34b is formed. In other words, two non-contact portions 53a and 53b are formed inside the contact convex portion 33.

The axial cover portion 28 includes a pair of relief recessed portions 37 recessed to the axially outer side from the reference surface 31 on both circumferentially outer side portions of the protruding portion 32 of the axially inner side surface. The relief recessed portions 37 are provided in portions of the axially inner side surface of the axial cover portion 28 that face a pair of outer guide portions 14 constituting the support 2 and the vicinity of the outer guide portions 14 in the axial direction. Specifically, the relief recessed portions 37 are provided in the portions that face the outer guide portion 14 in the axial direction, and in portions that face portions located in the vicinity of circumferentially inner sides of the outer guide portions 14 in the axial direction.

Each of the relief recessed portions 37 includes a deep recessed portion 37a on a circumferentially inner side portion thereof, and includes, on a circumferentially outer side of the deep recessed portion 37a, a shallow recessed portion 37b having a lower axial depth than that in the deep recessed portion 37a.

When wear of the inner pad 4 and the outer pad 5 progresses and the caliper body 3 moves to the axially inner side with respect to the support 2, an axially outer side portion of the outer guide portion 14 and axially outer side portions of pad clips 7a and 7b attached to circumferentially inner side surfaces of the outer guide portion 14 can be respectively inserted into the relief recessed portion 37. Specifically, the axially outer side portion of the outer guide portion 14 can be inserted into the shallow recessed portion 37b, and the axially outer side portions of the pad clip 7a and 7b can be inserted into the deep recessed portion 37a. With such a configuration, interference between the pair of outer guide portion 14 and the pad clips 7a and 7b and the outer body portion 21 is suppressed.

The axial cover portion 28 includes through holes 38 into which the axially outer side ends of the pad clips 7a and 7b can be inserted. The pad clips 7a and 7b used in the present embodiment have a configuration in which the curl portion 52 protrudes more to the axially outer side than other portions of the pad clips 7a and 7b as described later. Therefore, in the present embodiment, in order to suppress interference between a bottom surface of the deep recessed portion 37a and the curl portion 52, the through hole 38 into which only the curl portion 52 can be inserted is formed in the axial cover portion 28. Accordingly, as compared with a case where an axial depth of the entire deep recessed portion 37a is increased, a decrease in the rigidity of the outer body portion 21 is suppressed.

The through hole 38 opens only in the axially outer side surface and the axially inner side surface of the axial cover portion 28, and does not open in other portions (for example, the radial cover portion 29). In addition, the through holes 38 are formed in portions of the axial cover portion 28 that are located in the vicinity of the circumferentially inner side of the outer guide portion 14 and face an internal space of the outer side guide recessed groove 17 in the axial direction.

The axial cover portion 28 includes first recessed grooves 39 connected to the opening portion on the axially outer side of the through hole 38 on the axially outer side surface. Each of the first recessed grooves 39 extends in the circumferential direction, and a circumferentially inner side end is connected to the opening portion on the axially outer side of the through hole 38. Therefore, the axial cover portion 28 includes two first recessed grooves 39.

A width dimension of the first recessed groove 39 is substantially constant over an entire length of the first recessed groove 39, and is substantially the same as the radial dimension of the opening portion on the axially outer side of the through hole 38. In the present embodiment, the first recessed groove 39 is provided to be connected to the opening portion on the axially outer side of the through hole 38, and the width dimension of the first recessed groove 39 is substantially the same as the radial dimension of the opening portion on the axially outer side of the through hole 38. Therefore, the through hole 38 and the first recessed groove 39 can be smoothly continued, and the opening portion on the axially outer side of the through hole 38 can be made inconspicuous from the outside. In addition, the designability can be improved by taking in the opening portion on the axially outer side of the through hole 38 as a portion of the design of the design surface.

The axial cover portion 28 includes a second recessed groove 40 connecting the opening portions on the axially outer side of the through holes 38 on the axially outer side surface. The second recessed groove 40 extends in the circumferential direction and is curved such that the radially outer side is convex. A width dimension of the second recessed groove 40 is substantially constant over an entire length of the second recessed groove 40, and is substantially the same as the radial dimension of the opening portion on the axially outer side of the through hole 38. Therefore, a pair of first recessed grooves 39 disposed on both circumferential outer sides are smoothly continuous in the circumferential direction via a pair of through holes 38 and the second recessed groove 40.

The axial cover portion 28 includes an annular sector-shaped display portion 41 usable for displaying a logo or the like on the circumferentially intermediate portion of the axially outer side surface. The display portion 41 has a flat surface shape, and is disposed on a radially outer side of the pair of through holes 38 and the second recessed groove 40. In the present embodiment, since the circumferential dimension of the axial cover portion 28 is larger than the circumferential dimension of the support 2, a circumferential dimension of the display portion 41 can be sufficiently increased. Since both circumferential outer sides and a radially outer side of the display portion 41 are surrounded by a groove portion 42, the display portion 41 is visually recognized as being lifted to the axially outer side.

The radial cover portion 29 has a partially cylindrical shape and extends to an axially inner side from an outer peripheral edge portion of the axial cover portion 28. The radial cover portion 29 covers the pair of guide portions 9 constituting the support 2, a portion of the rotor 8 in the circumferential direction, and the inner pad 4 and the outer pad 5 from the radially outer side. A circumferential dimension of the radial cover portion 29 is the same as a circumferential dimension of the inner body portion 20.

The radial cover portion 29 includes attachment holes (screw holes) 43 for fixing distal end portions of the connection members 22a and 22b at a plurality of positions (four positions in the shown embodiment) in the circumferential direction. The plurality of attachment holes 43 are disposed at the same pitch in the circumferential direction with a plurality of insertion holes provided in the inner body portion 20. The attachment hole 43 opens in an axially inner side surface of the radial cover portion 29.

The radial cover portion 29 includes a central window 44 that opens on both radial sides on an axially inner side portion of a circumferential central portion. The central window 44 has an elongated slit shape in the axial direction. The central window 44 also opens to the axially inner side surface of the radial cover portion 29. The central window 44 can be used to visually check a wear state of the inner pad 4 and the outer pad 5.

The outer body portion 21 including the axial cover portion 28 and the radial cover portion 29 is fixed to an axially outer side of the inner body portion 20 using the connection members 22a and 22b, which are bolts. Specifically, a distal end portion of the connection member 22a inserted through an insertion hole provided in the circumferential arm portion 24 of the inner body portion 20 in the axial direction is screwed into the attachment hole 43 provided in a circumferentially outer side portion of the radial cover portion 29 of the outer body portion 21, and a distal end portion of the connection member 22b inserted through an insertion hole provided in the radially protruding portion 25 of the inner body portion 20 in the axial direction is screwed into the attachment hole 43 provided in a circumferentially inner side portion of the radial cover portion 29 of the outer body portion 21. Accordingly, the outer body portion 21 is connected to the axially outer side of the inner body portion 20 using the connection members 22a and 22b. Therefore, the outer body portion 21 has a cantilever structure in which the outer body portion 21 is connected to the inner body portion 20 only at a radially outer side portion.

In a state where the inner body portion 20 and the outer body portion 21 are connected to each other, a pair of opening portions 45 are formed between an axially outer side surface of the inner body portion 20 and an axially inner side surface of the outer body portion 21. The pair of opening portions 45 are separated from each other in the circumferential direction, and are disposed on both circumferential outer sides of the pair of radially protruding portions 25. Each of the opening portions 45 is formed in a substantially rectangular shape as viewed in the radial direction. In an assembled state of the disc brake device 1, an axially inner side portion of the caliper guide portion 15 constituting the support 2 is exposed from the opening portion 45.

The caliper body 3 is supported to be movable in the axial direction with respect to the support 2. For this purpose, the base end portion of the slide pin 19 is fixed to the fixing hole 26 provided in a circumferentially intermediate portion of the circumferential arm portion 24 constituting the inner body portion 20, and the front half portion of the slide pin 19 is inserted into the support hole 18 formed in the caliper guide portion 15 constituting the support 2 so as to be able to relatively displace (slide) in the axial direction. In addition, a portion of an outer circumferential surface of the slide pin 19 located between the support hole 18 and the fixing hole 26 is covered by a boot 46.

### Inner Pad and Outer Pad

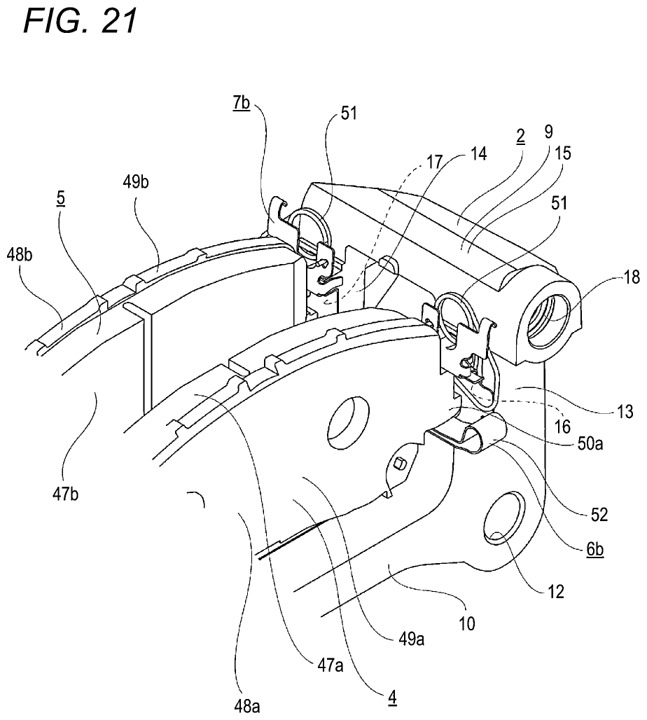

As shown in FIG. 21, the inner pad 4 includes a lining 47a and a back plate 48a, and is supported between a pair of inner guide portions 13 constituting the support 2 to be movable in the axial direction.

The back plate 48a includes a rectangular plate-shaped base plate portion 49a that supports a back surface (an axially inner side surface) of the lining 47a, and convex ear portions 50a that protrude from the base plate portion 49a toward both circumferential outer sides. The base plate portion 49a has a shape substantially matching the lining 47a.

In order to support the inner pad 4 such that the inner pad 4 is movable in the axial direction with respect to the pair of inner guide portions 13, the ear portions 50a constituting the inner pad 4 are engaged with the inner side guide recessed groove 16 provided in the inner guide portions 13 in a concave-convex manner.

The outer pad 5 includes a lining 47b and a back plate 48b, and is supported between a pair of outer guide portions 14 constituting the support 2 to be movable in the axial direction.

The back plate 48b includes a rectangular plate-shaped base plate portion 49b that supports the back surface of the lining 47b, and the convex ear portions 50b that protrude from the base plate portion 49b toward both circumferential outer sides. The base plate portion 49b has a shape substantially matching the lining 47b.

In order to support the outer pad 5 such that the outer pad 5 is movable in the axial direction with respect to the pair of outer guide portions 14, the ear portions 50b constituting the outer pad 5 are engaged with the outer side guide recessed groove 17 provided in the outer guide portions 14 in a concave-convex manner.

### Pad Clip

The pad clips 6a and 6b are interposed between both circumferential outer surfaces of the back plate 48a constituting the inner pad 4 and circumferentially inner side surfaces of the pair of inner guide portions 13. In addition, the pad clips 7a and 7b are interposed between both circumferential outer surfaces of the back plate 48b constituting the outer pad 5 and circumferentially inner side surfaces of the pair of outer guide portions 14. Accordingly, smooth axial movement of the inner pad 4 and the outer pad 5 are made possible.

The pad clips 6a, 6b, 7a, and 7b are formed by pressing a metal plate having elasticity and corrosion resistance, such as a stainless steel plate. As shown in FIG. 21, each of the pad clips 6a, 6b, 7a, and 7b is attached with a return spring 51 that urges the inner pad 4 and the outer pad 5 in a direction away from the rotor 8 when the braking force is released.

Among the four pad clips 6a, 6b, 7a, and 7b, the pair of pad clips 6a and 7a disposed on the rotation-in side (a right side in FIG. 18) and the pair of pad clips 6b and 7b disposed on the rotation-out side (a left side in FIG. 18) have symmetrical shapes in the axial direction. In addition, the pair of pad clips 6a and 6b disposed to face each other in the circumferential direction and the pair of pad clips 7a and 7b disposed to face each other in the circumferential direction have symmetrical shapes in the circumferential direction.

The pad clips 6a and 6b disposed on the axially inner side of the rotor 8 elastically press the inner pad 4 toward the circumferentially inner side and elastically press the ear portions 50a constituting the inner pad 4 toward the radially outer side.

The pad clips 7a and 7b disposed on the axially outer side of the rotor 8 elastically press the outer pad 5 toward the circumferentially inner side and elastically press the ear portions 50b constituting the outer pad 5 toward the radially outer side. In addition, as shown in FIG. 19, in a state where the pad clips 7a and 7b are attached to the circumferentially inner side surface of the outer guide portion 14, the axially outer side portions of the pad clips 7a and 7b are disposed to protrude to the axially outer side from the outer guide portion 14. In particular, among the pad clips 7a and 7b, the curl portion 52 having a partially cylindrical shape for elastically pressing the ear portions 50b toward the radially outer side protrudes more to the axially outer side than the other portions of the pad clips 7a and 7b, and is disposed to protrude most to the axially outer side from the outer guide portion 14.

Therefore, when wear of the inner pad 4 and the outer pad 5 progresses and the caliper body 3 moves to the axially inner side with respect to the support 2, the curl portion 52 constituting the pad clips 7a and 7b easily interferes with the axial cover portion 28 constituting the outer body portion 21 during braking. In the present embodiment, since the through holes 38 are provided in portions of the axial cover portion 28 that face the internal space of the outer side guide recessed groove 17 in the axial direction, and the curl portion 52 can be inserted into the through holes 38, interference between the curl portion 52 and the axial cover portion 28 can be suppressed.

### Description of Operation of Disc Brake Device

In order to perform braking by the disc brake device 1 according to the present embodiment, pressure oil is fed from a master cylinder to the cylinder 23 of the caliper body 3. Accordingly, a piston (not shown) is pushed to the axially outer side. The inner pad 4 is pressed against the axially inner side surface of the rotor 8 by the piston, and the caliper body 3 is moved to the axially inner side with respect to the support 2. Accordingly, the contact convex portion 33 of the protruding portion 32 provided in the axial cover portion 28 constituting the caliper body 3 is pressed against a back surface of the back plate 48b constituting the outer pad 5. Thus, the outer pad 5 is pressed against an axially outer side surface of the rotor 8. As a result, the rotor 8 is strongly clamped by the inner pad 4 and the outer pad 5 from both axial sides to perform braking.

When the braking is released, the pressure oil is discharged from the cylinder 23 of the caliper body 3. Accordingly, the piston is pulled back (rolled back) to a back side (an axially inner side) of the cylinder 23 by an elastic restoring force of a piston seal (not shown) externally fitted to the piston, and a clearance between the inner pad 4 and the axially inner side surface of the rotor 8 is secured. As a result, the caliper body 3 slightly moves to the axially outer side with respect to the support 2, and a clearance between the outer pad 5 and the axially outer side surface of the rotor 8 is also secured.

According to the disc brake device 1 in the present embodiment as described above, it is possible to suppress a surface pressure of a contact portion between the outer body portion 21 of the caliper body 3 and the outer pad 5 from locally increasing in a radially outer side portion of the outer pad 5.

That is, in the present embodiment, not the entire axially inner side surface (the distal end surface) of the protruding portion 32 provided in the outer body portion 21 is brought into contact with the axially outer side surface of the base plate portion 49b of the outer pad 5, but only a distal end surface of the contact convex portion 33 formed on the axially inner side surface of the protruding portion 32 is brought into contact with the axially outer side surface of the base plate portion 49b. In addition, in the present embodiment, by adjusting a shape and a formation position of the contact convex portion 33, the area of the portion facing the radially inner side half portion of the base plate portion 49b in the axial direction is made larger than the area of the portion facing the radially outer side half portion of the base plate portion 49b in the axial direction.

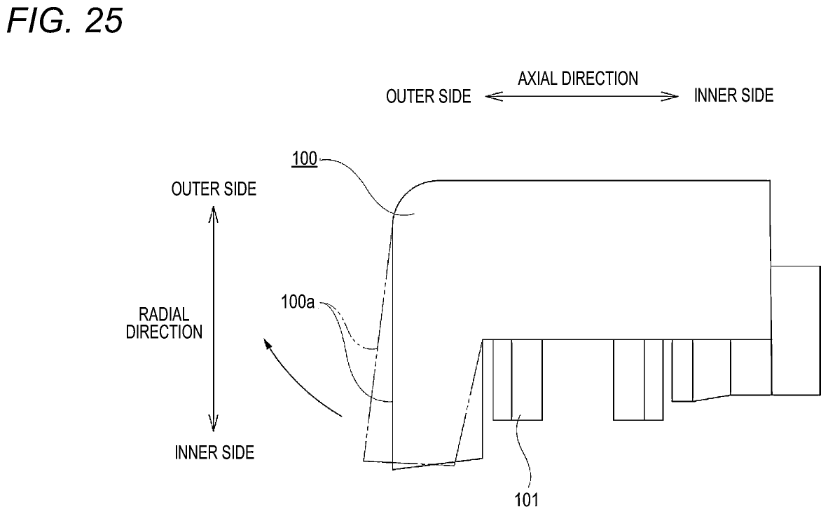

Therefore, when the axial cover portion 28 of the outer body portion 21 is elastically deformed on the axially outer side and on the radially outer side during braking as shown in FIG. 25, a contact area between the distal end surface of the contact convex portion 33 and the radially inner side half portion of the axially outer side surface of the base plate portion 49b can be secured sufficiently. Accordingly, it is possible to suppress the surface pressure of the contact portion between the outer body portion 21 and the outer pad 5 from locally increasing in the radially outer side portion of the outer pad 5. As a result, since it is possible to reduce the deviation of a surface pressure of the outer pad 5 with respect to the rotor 8, it is possible to suppress the occurrence of uneven wear in the lining 47b of the outer pad 5 and the occurrence of noise during braking.

In addition, in the present embodiment, the radial convex portions 34a and 34b extending in the radial direction and constituting the contact convex portion 33 are disposed in the vicinity of a circumferentially inner side of the central axis O of each of the cylinders 23, and the circumferential convex portion 35a extending in the circumferential direction and constituting the contact convex portion 33 is disposed at a radial position intersecting the central axis O of each of the cylinders 23. Therefore, the surface pressure of the contact portion between the outer body portion 21 and the outer pad 5 can be secured sufficiently in a radially intermediate portion of the outer pad 5. Accordingly, a contact area between the rotor 8 and the lining 47b of the outer pad 5 can be increased, and the deviation of the surface pressure of the outer pad 5 with respect to the rotor 8 can be reduced.

In addition, since the circumferential convex portion 35b extending in the circumferential direction and constituting the contact convex portion 33 is disposed at the inner circumferential edge portion of the axially inner side surface of the protruding portion 32, a surface pressure on the radially inner side portion (an inner circumferential edge portion) of the outer pad 5 where the surface pressure tends to be the lowest when it is assumed that the contact convex portion 33 is not provided, can be secured.

In addition, the bending rigidity of the axial cover portion 28 of the outer body portion 21 can be increased by the radial convex portions 34a and 34b extending in the radial direction and constituting the contact convex portion 33. Therefore, the axial cover portion 28 can be suppressed from being elastically deformed as shown in FIG. 25. Accordingly, from this point of view, it is possible to suppress the surface pressure of the contact portion between the outer body portion 21 and the outer pad 5 from locally increasing in the radially outer side portion of the outer pad 5.

In addition, in the present embodiment, in the outer body portion 21, a portion between the outer peripheral edge portion of the axially inner side surface of the axial cover portion 28 and the axially outer side end of the radially inner side surface of the radial cover portion 29 is reinforced by the reinforcing rib 36. Therefore, the reinforcing rib 36 can also suppress the axial cover portion 28 from being elastically deformed as shown in FIG. 25. Further, since the reinforcing rib 36 is connected to the radially outer side ends of the radial convex portions 34a and 34b, an effect of improving the rigidity can be enhanced as compared with a case where the reinforcing rib 36 is not connected to the radial convex portion 34. Accordingly, from this point of view, it is possible to suppress the surface pressure of the contact portion between the outer body portion 21 and the outer pad 5 from locally increasing in the radially outer side portion of the outer pad 5.

### Second Embodiment

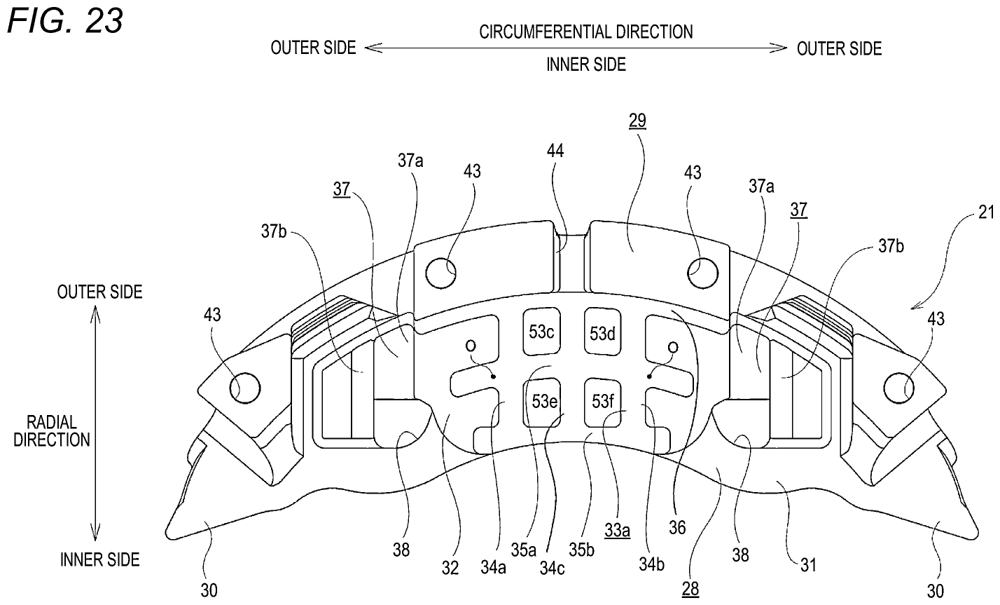

A second embodiment will be described with reference to FIG. 23.

In the present embodiment, only a shape of the contact convex portion 33a provided on the axially inner side surface of the protruding portion 32 of the outer body portion 21 is changed from the structure of the first embodiment.

That is, in the present embodiment, the contact convex portion 33a includes three radial convex portions 34a, 34b, and 34c and two circumferential convex portions 35a and 35b. That is, the contact convex portion 33a has a configuration in which one strip-shaped radial convex portion 34c extending in the radial direction is added to the contact convex portion 33 having a structure of the first embodiment. The radial convex portion 34c is disposed at a circumferential central portion of the axially inner side surface of the protruding portion 32, and is disposed parallel to the remaining two radial convex portions 34a and 34b. In the present embodiment, four non-contact portions 53c, 53d, 53e, and 53f each having a substantially rectangular shape are formed inside the contact convex portion 33b.

In the present embodiment having the above configuration, since the contact convex portion 33a includes an additional radial convex portion 34a extending in the radial direction as compared with the structure of the first embodiment, the bending rigidity of the axial cover portion 28 of the outer body portion 21 can be further increased. Therefore, it is possible to reduce an amount of elastic deformation of the axial cover portion 28, and it is possible to more effectively suppress the surface pressure of the contact portion between the outer body portion 21 and the outer pad 5 from locally increasing in the radially outer side portion of the outer pad 5.

Other configurations, operations, and effects are the same as those of the first embodiment.

### Third Embodiment

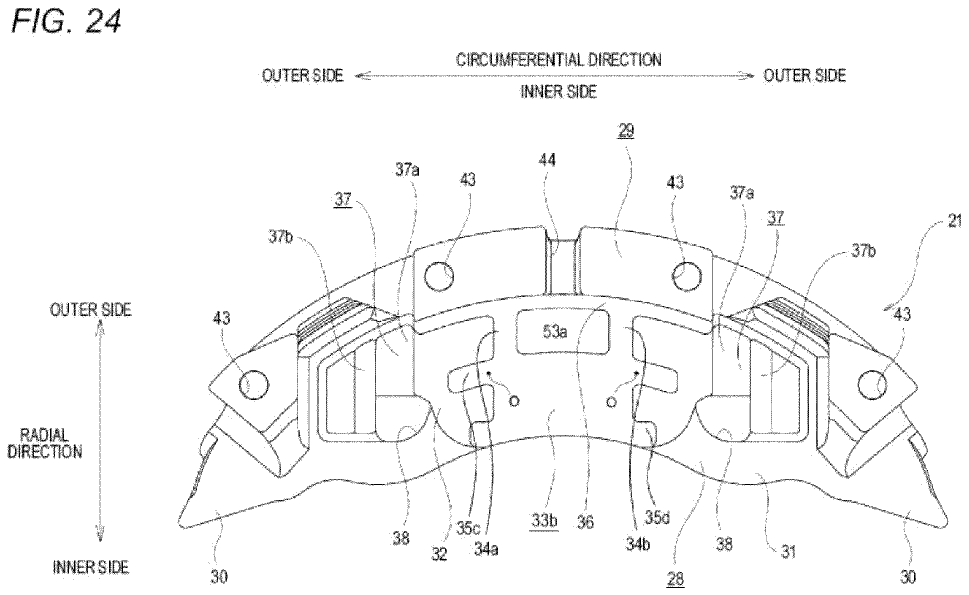

A third embodiment will be described with reference to FIG. 24.

In the present embodiment, only a shape of the contact convex portion 33b provided on the axially inner side surface of the protruding portion 32 of the outer body portion 21 is changed from the structure of the first embodiment.

That is, in the case of the present embodiment, the contact convex portion 33b also includes the two radial convex portions 34a and 34b and the two circumferential convex portions 35c and 35d, but width dimensions of the two circumferential convex portions 35c and 35d in circumferentially intermediate portions is different from the structure of the first embodiment. In the present embodiment, by increasing the width dimensions of the two circumferential convex portions 35c and 35d in the circumferentially intermediate portions, the circumferentially intermediate portions of the two circumferential convex portions 35c and 35d are connected to each other in the radial direction. Therefore, only one non-contact portion 53a is formed inside the contact convex portion 33a. In other words, in the present embodiment, a rectangular convex portion having the same shape as the non-contact portion 53b is newly formed at a position of the non-contact portion 53b in the structure of the first embodiment.

In the present embodiment as described above, a contact area between the contact convex portion 33b and the radially inner side half portion of the base plate portion 49b can be increased more than that in the structure of the first embodiment. Therefore, it is possible to more effectively suppress the surface pressure of the contact portion between the outer body portion 21 of the caliper body 3 and the outer pad 5 from locally increasing in the radially outer side portion of the outer pad 5.

Other configurations, operations, and effects are the same as those of the first embodiment.

Although the embodiments of the present invention have been described above, the present invention is not limited thereto, and can be appropriately changed without departing from the technical concept of the invention. In addition, the structures of the embodiments can be appropriately combined and implemented as long as no contradiction occurs.

In the structures of the embodiments, a case where a contact convex portion is constituted by a radial convex portion and a circumferential convex portion has been described, but when the present invention is implemented, the contact convex portion may be constituted by only the radial convex portion or only the circumferential convex portion, or may be constituted by a convex portion having another shape.

In the structures according to the embodiments, a structure in which the inner body portion includes two cylinders is shown, but when the present invention is implemented, the number of cylinders may be one or three or more.

Here, features of the above-described embodiments of the floating-type disc brake device according to the present invention will be briefly summarized and listed below.
[1]
A floating-type disc brake device (1) including:
an inner pad (4) configured to be disposed on an axially inner side of a rotor (8);
an outer pad (5) configured to be disposed on an axially outer side of the rotor (8);
a support (2) configured to be fixed to a vehicle body and configured to support the inner pad (4) and the outer pad (5) such that the inner pad (4) and the outer pad (5) are movable in an axial direction; and
a caliper body (3) supported to be movable in the axial direction with respect to the support (2), in which
the outer pad (5) includes a back plate (48b) including an ear portion (50b) and a base plate portion (49b) configured to support a lining (47b),
the caliper body (3) includes a cylinder (23), and includes an inner body portion (20) configured to be disposed on an axially inner side of the rotor (8), and an outer body portion (21) configured to press the outer pad (5) during braking,
the outer body portion (21) includes a protruding portion (32) configured to protrude to the axially inner side over substantially an entire portion facing the base plate portion (49b) in the axial direction, and
the protruding portion (32) includes, on an axially inner side surface thereof, a contact convex portions (33, 33a, 33b) configured to rise in the axial direction and in which an area of a portion facing a radially inner side half portion of the base plate portion (49b) in the axial direction is larger than an area of a portion facing a radially outer side half portion of the base plate portion (49b) in the axial direction, and
in the outer body portion (21), only a distal end surface of the contact convex portions (33, 33a, 33b) is configured to be brought into contact with an axially outer side surface of the base plate portion (49b) during braking.
[2]
The floating-type disc brake device (1) according to [1], in which
the outer body portion (21) includes a pair of relief recessed portions (37) recessed to the axially outer side on both circumferentially outer side portions of the protruding portion (32), the pair of relief recessed portions allowing an axially outer side portion of the support (2) to be inserted when wear of the inner pad (4) and the outer pad (5) progresses.
[3]
The floating-type disc brake device (1) according to any one of [1] to [2], in which
an axial height of the contact convex portion (33, 33a, 33b) is constant.
[4]
The floating-type disc brake device (1) according to any one of [1] to [3], in which
the contact convex portion (33, 33a, 33b) includes a strip-shaped radial convex portion (34a, 34b, 34c) that extends in a radial direction.
[5]
The floating-type disc brake device (1) according to [4], in which
the radial convex portion (34a, 34b, 34c) is disposed on a central axis (O) of the cylinder (23) or in a vicinity of the central axis.
[6]
The floating-type disc brake device (1) according to any one of [4] to [5], in which
a plurality of radial convex portions (34a, 34b, 34c) are provided to be separated from each other in a circumferential direction, and
the plurality of radial convex portions (34a, 34b, 34c) are disposed in parallel to each other.
[7]
The floating-type disc brake device (1) according to any one of [4] to [6], in which
the protruding portion (32) includes a reinforcing rib (36) on an outer peripheral edge portion of the axially inner side surface of the protruding portion (32), the outer peripheral edge portion being deviated on a radially outer side from a portion facing the base plate portion (49b) in the axial direction, and
a radially outer side end of each of the radial convex portions (34a, 34b, 34c) is connected to the reinforcing rib (36).
[8]
The floating-type disc brake device (1) according to any one of [1] to [7], in which
the contact convex portion (33, 33a, 33b) includes a strip-shaped circumferential convex portion (35a, 35b) that extends in a circumferential direction.
[9]
The floating-type disc brake device (1) according to [8] depending on any one of [4] to [7], in which
the circumferential convex portion (35a, 35b) is disposed to intersect the radial convex portion (34a, 34b, 34c).
[10]
The floating-type disc brake device (1) according to any one of [8] to [9], in which
a plurality of circumferential convex portions (35a, 35b) are provided to be separated from each other in a radial direction.
[11]
The floating-type disc brake device (1) according to any one of [8] to [10], in which
the circumferential convex portion (35a, 35b) is disposed at a radial position intersecting a central axis (O) of the cylinder (23).
[12]
The floating-type disc brake device (1) according to any one of [8] to [10], in which
the circumferential convex portion (35a, 35b) is disposed at a position deviated to a radially inner side from a central axis (O) of the cylinder (23).
[13]
The floating-type disc brake device (1) according to any one of [8] to [12], in which
the circumferential convex portion (35a, 35b) is curved to be convex on a radially outer side.
[14]
The floating-type disc brake device (1) according to any one of [1] to [13], in which
the outer body portion (21) has a circumferential dimension larger than a circumferential dimension of the support (2).

The present application is based on a Japanese Patent Application (Japanese Patent Application No. 2021-205029) filed on Dec. 17, 2021, and the content thereof is incorporated herein by reference.

### INDUSTRIAL APPLICABILITY

According to the disc brake device of the present invention, it is possible to realize a floating-type disc brake device capable of suppressing a surface pressure of a contact portion between an outer body portion of a caliper body and an outer pad from locally increasing in a radially outer side portion of the outer pad.

### REFERENCE SIGNS LIST

1: disc brake device
2: support
3: caliper body
4: inner pad
5: outer pad
6a, 6b: pad clip
7a, 7b: pad clip
8: rotor
9: guide portion
10: inner side circumferential connection portion
11: outer side circumferential connection portion
12: attachment hole
13: inner guide portion
14: outer guide portion
15: caliper guide portion
16: inner side guide recessed groove
17: outer side guide recessed groove
18: support hole
19: slide pin
20: inner body portion
21: outer body portion
22a, 22b: connection member
23: cylinder
24: circumferential arm portion
25: radially protruding portion
26: fixing hole
27: strip-shaped rib
28: axial cover portion
29: radial cover portion
30: blade portion
31: reference surface
32: protruding portion
33, 33a, 33b: contact convex portion
34a, 34b, 34c: radial convex portion
35a, 35b: circumferential convex portion
36: reinforcing rib
37: relief recessed portion
37a: deep recessed portion
37b: shallow recessed portion
38: through hole
39: first recessed groove
40: second recessed groove
41: display portion
42: groove portion
43: attachment hole
44: central window
45: opening portion
46: boot
47a, 47b: lining
48a, 48b: back plate
49a, 49b: base plate portion
50a, 50b: ear portion
51: return spring
52: curl portion
53a to 53f: non-contact portion
54: contact surface
100: outer body portion
100a: pad pressing portion
101: outer pad

1. A floating-type disc brake device comprising:
an inner pad configured to be disposed on an axially inner side of a rotor;
an outer pad configured to be disposed on an axially outer side of the rotor;
a support configured to be fixed to a vehicle body and configured to support the inner pad and the outer pad such that the inner pad and the outer pad are movable in an axial direction; and
a caliper body supported to be movable in the axial direction with respect to the support, wherein
the outer pad includes a back plate including an ear portion and a base plate portion configured to support a lining,
the caliper body includes a cylinder, and includes an inner body portion configured to be disposed on the axially inner side of the rotor, and an outer body portion configured to press the outer pad during braking,
the outer body portion includes a protruding portion configured to protrude to the axially inner side over substantially an entire portion facing the base plate portion in the axial direction,
the protruding portion includes, on an axially inner side surface thereof, a contact convex portion configured to rise in the axial direction and in which an area of a portion facing a radially inner side half portion of the base plate portion in the axial direction is larger than an area of a portion facing a radially outer side half portion of the base plate portion in the axial direction, and
in the outer body portion, only a distal end surface of the contact convex portion is configured to be brought into contact with an axially outer side surface of the base plate portion during braking.

2. The floating-type disc brake device according to claim 1, wherein
the outer body portion includes a pair of relief recessed portions recessed to the axially outer side on both circumferentially outer side portions of the protruding portion, the pair of relief recessed portions allowing an axially outer side portion of the support to be inserted when wear of the inner pad and the outer pad progresses.

3. The floating-type disc brake device according to any one of claims 1 to 2, wherein
an axial height of the contact convex portion is constant.

4. The floating-type disc brake device according to any one of claims 1 to 3, wherein
the contact convex portion includes a strip-shaped radial convex portion that extends in a radial direction.

5. The floating-type disc brake device according to claim 4, wherein
the radial convex portion is disposed on a central axis of the cylinder or in a vicinity of the central axis.

6. The floating-type disc brake device according to any one of claims 4 to 5, wherein
a plurality of radial convex portions are provided to be separated from each other in a circumferential direction, and
the plurality of radial convex portions are disposed in parallel to each other.

7. The floating-type disc brake device according to any one of claims 4 to 6, wherein
the protruding portion includes a reinforcing rib on an outer peripheral edge portion of the axially inner side surface of the protruding portion, the outer peripheral edge portion being deviated on a radially outer side from a portion facing the base plate portion in the axial direction, and
a radially outer side end of each of the radial convex portions is connected to the reinforcing rib.

8. The floating-type disc brake device according to any one of claims 1 to 7, wherein
the contact convex portion includes a strip-shaped circumferential convex portion that extends in a circumferential direction.

9. The floating-type disc brake device according to claim 8 depending on any one of claims 4 to 7, wherein
the circumferential convex portion is disposed to intersect the radial convex portion.

10. The floating-type disc brake device according to any one of claims 8 to 9, wherein
a plurality of circumferential convex portions are provided to be separated from each other in a radial direction.

11. The floating-type disc brake device according to any one of claims 8 to 10, wherein
the circumferential convex portion is disposed at a radial position intersecting a central axis of the cylinder.

12. The floating-type disc brake device according to any one of claims 8 to 10, wherein
the circumferential convex portion is disposed at a position deviated to a radially inner side from a central axis of the cylinder.

13. The floating-type disc brake device according to any one of claims 8 to 12, wherein
the circumferential convex portion is curved to be convex on a radially outer side.

14. The floating-type disc brake device according to any one of claims 1 to 13, wherein
the outer body portion has a circumferential dimension larger than a circumferential dimension of the support.
